(19) United States
(12) Patent Application Publication
(10) Pub. No.: US 2021/0197836 A1
(43) Pub. Date: Jul. 1, 2021

(54) INERTIAL MEASUREMENT DEVICE, ELECTRONIC APPARATUS, AND MOVING OBJECT

(71) Applicant: SEIKO EPSON CORPORATION, Tokyo (JP)

(72) Inventors: Ryuji Kihara, Matsumoto-shi (JP); Kentaro Yoda, Chino-shi (JP); Shogo Okamoto, Shimosuwa-machi (JP)

(21) Appl. No.: 17/125,272

(22) Filed: Dec. 17, 2020

(30) Foreign Application Priority Data
Dec. 20, 2019 (JP) 2019-230174

(51) Int. Cl. B60W 40/10; G01P 3/44; G01P 15/18; B60W 30/00

(52) U.S. Cl. CPC B60W 40/10; B60W 30/00; G01P 15/18; G01P 3/44

(57) ABSTRACT

An inertial measurement device includes a sensor unit having an angular velocity sensor and an acceleration sensor, an elastic member that has a first portion, a second portion facing the first portion, and a third portion coupled to the second portion, and sandwiches the sensor unit between the first portion and the second portion, a fixing portion on which the sensor unit and the elastic member are disposed and which is in contact with the second portion, and a fixing member that fixes the sensor unit and the elastic member to the fixing portion. The fixing member passes through the sensor unit and the elastic member, and presses and fixes the elastic member. The third portion of the elastic member is positioned between the sensor unit and the fixing member.

The present application is based on, and claims priority from JP Application Serial Number 2019-230174, filed Dec. 20, 2019, the disclosure of which is hereby incorporated by reference herein in its entirety.

### BACKGROUND

### 1. Technical Field

The present disclosure relates to an inertial measurement device, an electronic apparatus, and a moving object.

### 2. Related Art

An inertial measurement device (Inertial Measurement Unit (IMU)) that includes an angular velocity sensor or an acceleration sensor and is used for posture control of a moving object or the like is known.

For example, JP-A-2007-40766 discloses a sensor unit as an inertial measurement device in which three acceleration sensors configured to detect accelerations in X-axis, Y-axis, and Z-axis directions, respectively, and a temperature sensor are bonded to respective surfaces of a block, three angular velocity sensors configured to detect angular velocities around the respective axes are fastened and fixed to support rods through rubber bushings as vibration-proof rubber with screws, thereby reducing an influence of a temperature drift.

However, the inertial measurement device described in JP-A-2007-40766 has a problem that the three acceleration sensors are easily influenced by vibration from the outside because the three acceleration sensors are bonded directly to the block.

### SUMMARY

An inertial measurement device includes a sensor unit that has an angular velocity sensor and an acceleration sensor, an elastic member that has a first portion, a second portion facing the first portion, and a third portion coupled to the second portion, and sandwiches the sensor unit between the first portion and the second portion, a fixing portion on which the sensor unit and the elastic member are disposed and which is in contact with the second portion, and a fixing member that fixes the sensor unit and the elastic member to the fixing portion, in which the fixing member passes through the sensor unit and the elastic member, and presses and fixes the elastic member, and the third portion of the elastic member is positioned between the sensor unit and the fixing member.

An electronic apparatus includes the inertial measurement device described above, and a controller that performs control based on a detection signal output from the inertial measurement device.

A moving object includes the inertial measurement device described above, and a posture controller that performs control of a posture based on a detection signal output from the inertial measurement device.

### BRIEF DESCRIPTION OF THE DRAWINGS

FIG. 1 is a perspective view showing a schematic structure of an inertial measurement device according to a first embodiment.

FIG. 2 is a plan view showing a schematic structure of the inertial measurement device of FIG. 1.

FIG. 3 is a sectional view taken along the line III-III of FIG. 2.

FIG. 4 is an enlarged view of a portion IV of FIG. 3.

FIG. 5 is a graph showing a vibration characteristic of the inertial measurement device.

FIG. 6 is an exploded perspective view showing a schematic structure of a sensor unit.

FIG. 7 is a perspective view showing a schematic structure of a substrate of the sensor unit.

FIG. 8 is a perspective view showing a schematic structure of an inertial measurement device according to a second embodiment.

FIG. 9 is a perspective view showing a schematic structure of an inertial measurement device according to a third embodiment.

FIG. 10 is a plan view showing the inertial measurement device of FIG. 9.

FIG. 11 is a perspective view showing a schematic structure of an inertial measurement device according to a fourth embodiment.

FIG. 12 is a plan view showing a schematic structure of the inertial measurement device of FIG. 11.

FIG. 13 is an exploded side view showing a schematic structure of the inertial measurement device of FIG. 11.

FIG. 14 is a perspective view showing a schematic structure of an inertial measurement device according to a fifth embodiment.

FIG. 15 is a sectional view showing a sensor unit fixed state of FIG. 14.

FIG. 16 is a perspective view showing an example of an electronic apparatus including the inertial measurement device of the embodiment.

FIG. 17 is a diagram showing an example of a moving object including the inertial measurement device of the embodiment.

FIG. 18 is a block diagram showing a configuration example of the moving object.

### DESCRIPTION OF EXEMPLARY EMBODIMENTS

### 1. Inertial Measurement Device

### 1.1. First Embodiment

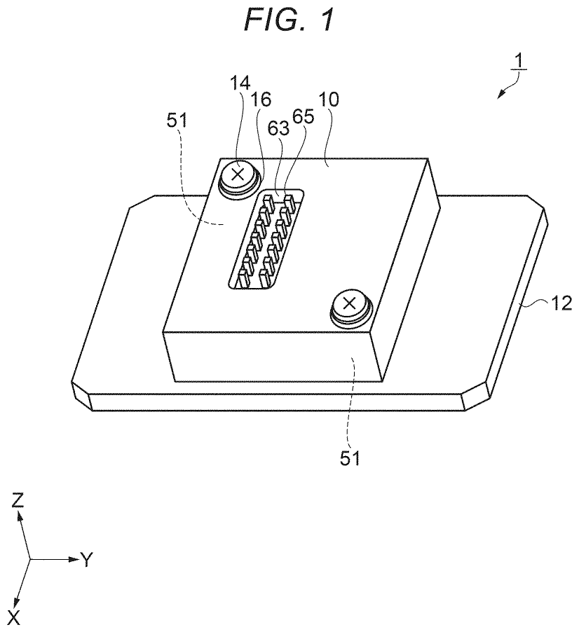

First, an inertial measurement device 1 according to a first embodiment will be described referring to FIGS. 1 to 5.

The inertial measurement device 1 is configured of a sensor unit 10 that incorporates a three-axis acceleration sensor and a three-axis angular velocity sensor, and a fixing portion 12 that corresponds to a bottom surface of a case of the inertial measurement device 1. In the embodiment, a case body, a control circuit, and the like of the inertial measurement device 1 are not shown.

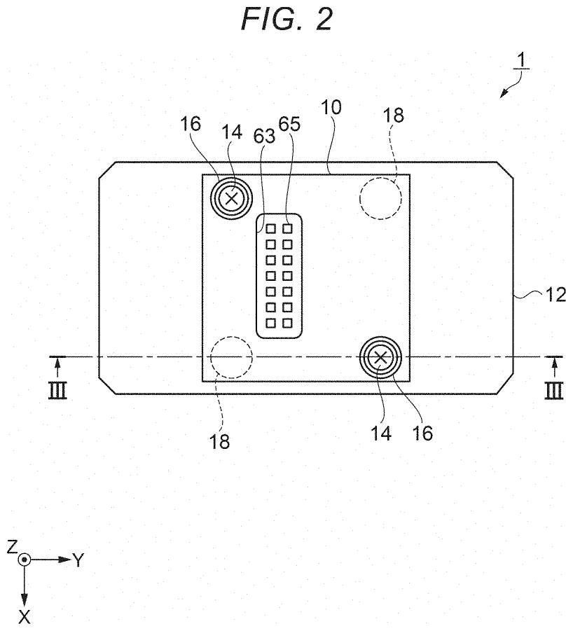

As shown in FIGS. 1 and 2, the sensor unit 10 is a rectangular parallelepiped having a substantially square planar shape, and screw holes 51 are formed in the vicinity of two vertices positioned in a diagonal direction of the square. Fixing members 14 as screws are inserted into the screw holes 51 and are fixed to the fixing portion 12 corresponding to the bottom surface of the case of the inertial measurement device 1. An opening 63 is provided in a surface of the sensor unit 10 on a side opposite to the fixing portion 12 side, that is, an upper surface, and a first connector 65 for electrical coupling to a control circuit (not shown) is disposed in the opening 63.

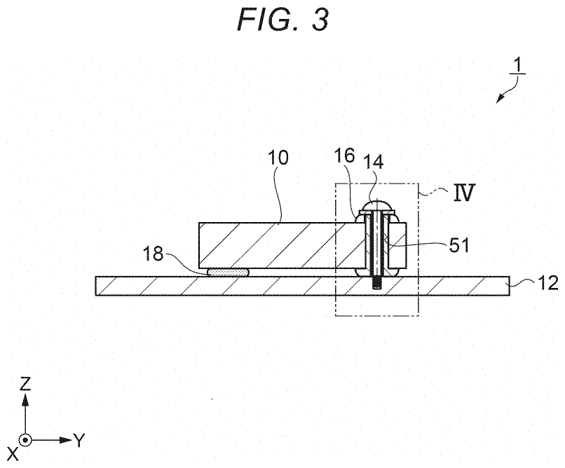

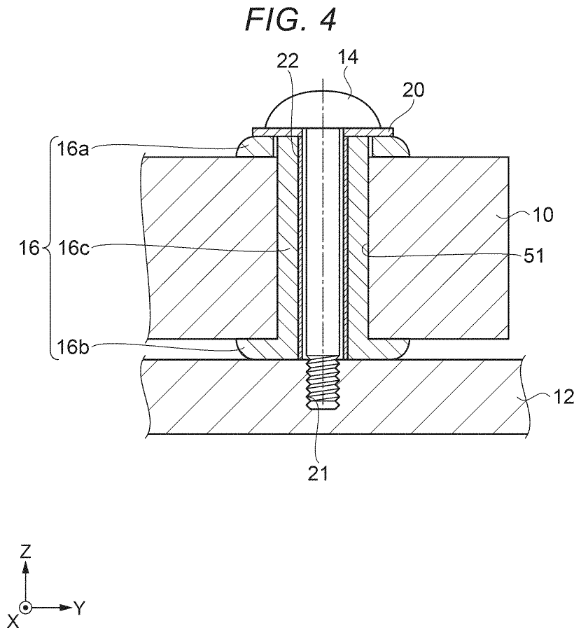

Fixing of the sensor unit 10 to the fixing portion 12 is performed by inserting the fixing members 14 into the screw holes 51 as shown in FIGS. 3 and 4. Specifically, a second portion 16b of an elastic member 16 including a first portion 16a, the second portion 16b facing the first portion 16a, and a third portion 16c being coupled to the second portion 16b and having a through-hole is disposed between the sensor unit 10 and the fixing portion 12, the fixing member 14 is inserted into the through-hole of the third portion 16c, and the fixing member 14 is screwed in the screw hole 21 provided in the fixing portion 12. In this way, fixing is performed. At the time of screwing, the fixing member 14 presses the elastic member 16. A washer 20 is disposed between a portion of the fixing member 14 equivalent to a head portion of a screw and the elastic member 16.

The elastic member 16 is configured of the first portion 16a that is disposed on a side opposite to the fixing portion 12 side, the second portion 16b that is integrated with the third portion 16c, and a control member 22 that controls a pressing amount of the elastic member 16 to the fixing member 14. The elastic member 16 is a high-strength gelatinous or rubbery bushing, and is a member having rigidity lower than the fixing member 14. The control member 22 is disposed between the third portion 16c and the fixing member 14 with a gap from the fixing member 14. The control member 22 is disposed, thereby restraining significant deformation of the elastic member 16 and deterioration of a vibration-proof characteristic. The control member 22 has a cylindrical shape surrounding the fixing member 14, and is configured of a member having rigidity higher than the elastic member 16.

Two support members 18 are disposed between the sensor unit 10 and the fixing portion 12 in the vicinity of vertices in a diagonal direction intersecting the diagonal direction in which the two screw holes 51 are formed. With this, it is possible to fix the sensor unit 10 substantially horizontally with respect to the fixing portion 12, and to measure inertia with high accuracy. The support member 18 is formed of the same material as the elastic member 16, and has the same thickness as the second portion 16b of the elastic member 16. For this reason, when the elastic member 16 is pressed and fixed by the fixing member 14, it is possible to maintain the sensor unit 10 in a substantially horizontal state with respect to the fixing portion 12.

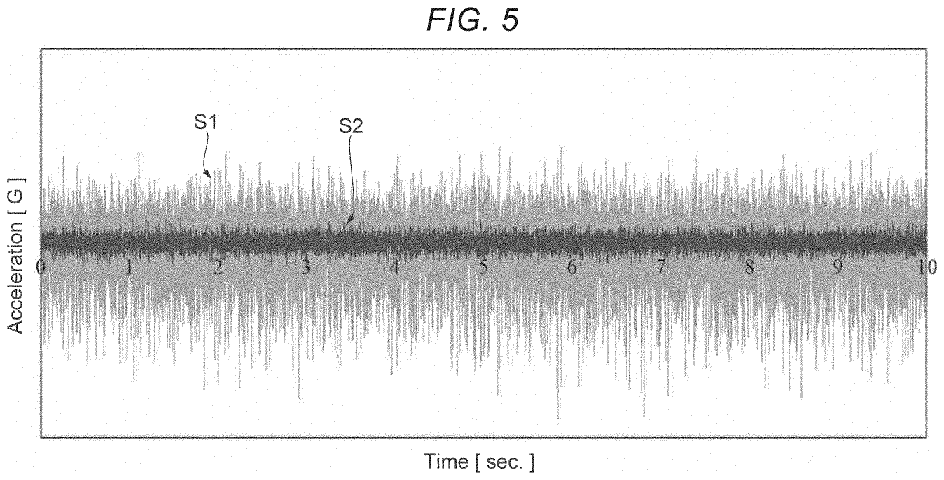

FIG. 5 is a graph showing a result of a vibration test on the inertial measurement device 1. S1 is a vibration characteristic when the sensor unit 10 is fixed directly to the fixing portion 12 having a structure of the related art, and S2 is a vibration characteristic of the inertial measurement device 1 of the embodiment. From FIG. 5, in the inertial measurement device 1 of the embodiment, an amplitude width of vibration is small and an influence of vibration is small compared to the structure of the related art. This is because the inertial measurement device 1 of the embodiment is configured such that the second portion 16b of the elastic member 16 is disposed and fixed between the sensor unit 10 and the fixing portion 12, and external vibration is hardly transmitted from the fixing portion 12 to the sensor unit 10. This is because the third portion 16c of the elastic member 16 is disposed between the sensor unit 10 and the fixing member 14, the sensor unit 10 and the fixing member 14 are not in contact with each other, and external vibration is hardly transmitted from the fixing member 14 coupled to the fixing portion 12 to the sensor unit 10. For this reason, the inertial measurement device 1 of the embodiment can perform excellent inertial measurement.

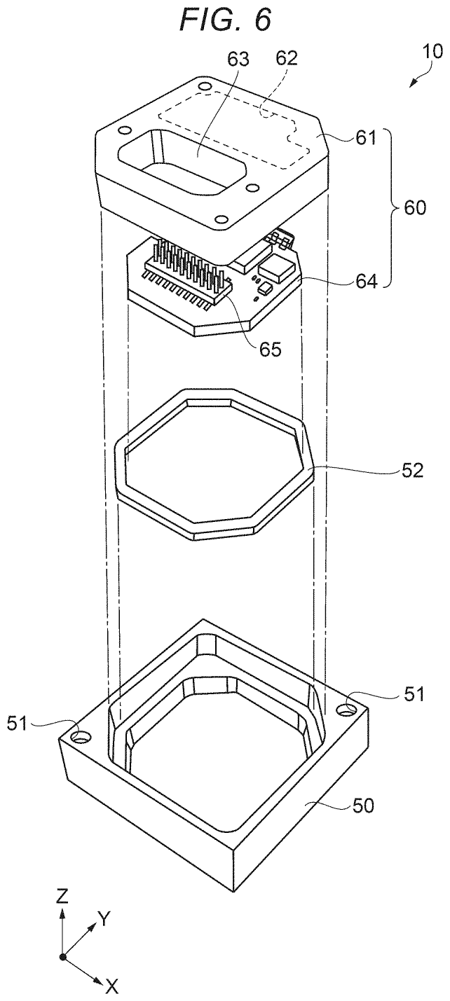

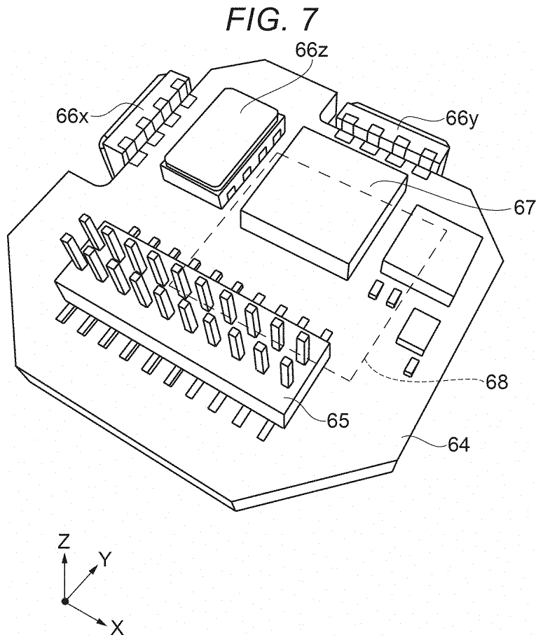

Next, the sensor unit 10 will be described referring to FIGS. 6 and 7.

The sensor unit 10 functions as a six-axis motion sensor including a three-axis acceleration sensor and a three-axis angular velocity sensor.

As shown in FIG. 6, the sensor unit 10 has an outer case 50, a bonding member 52, and a sensor module 60, and is configured such that the sensor module 60 is inserted into the outer case 50 with the bonding member 52 interposed therebetween. Similarly to the overall shape of the sensor unit 10 described above, the appearance of the outer case 50 is a rectangular parallelepiped having a substantially square planar shape, and screw holes 51 are formed in the vicinity of two vertices positioned in a diagonal direction of the square, respectively. The outer case 50 has a box shape, and the sensor module 60 is accommodated therein.

The sensor module 60 has an inner case 61 and a substrate 64. The inner case 61 is a member that supports the substrate 64, and has a shape that fits inside the outer case 50. In the inner case 61, a recess portion 62 that is provided for reducing a possibility of contact with the substrate 64 and the opening 63 that is provided for exposing the first connector 65 described below are formed. Such an inner case 61 is bonded to the outer case 50 through the bonding member 52. The substrate 64 is bonded to a lower surface of the inner case 61 through an adhesive.

As shown in FIG. 7, the first connector 65, an angular velocity sensor 66z that detects an angular velocity around the Z-axis, and an acceleration sensor 67 that detects an acceleration in each axial direction of an X-axis, a Y-axis, and the Z-axis, and the like are mounted on an upper surface of the substrate 64. An angular velocity sensor 66x that detects an angular velocity around the X-axis and an angular velocity sensor 66y that detects an angular velocity around the Y-axis are mounted on side surfaces of the substrate 64.

A control IC 68 is mounted on a lower surface of the substrate 64. The control IC 68 is a micro controller unit (MCU) and controls each section of the sensor unit 10. In a storage section of the control IC 68, programs that define an order and contents for detecting the acceleration and the angular velocity, programs that digitizes detection data and incorporates the digitized detection data into packet data, accompanying data, and the like are stored. In addition, a plurality of electronic components are mounted on the substrate 64.

The above-described sensor unit 10 can be reduced in size, for example, to be mounted in a smartphone or a digital camera by selection of components or design change.

As described above, in the inertial measurement device 1 of the embodiment, when the sensor unit 10 is fixed to the fixing portion 12, the second portion 16b of the elastic member 16 is disposed and fixed between the sensor unit 10 and the fixing portion 12. Thus, it is possible to make external vibration hard to be transmitted from the fixing portion 12 to the sensor unit 10. Since the third portion 16c of the elastic member 16 is positioned between the sensor unit 10 and the fixing member 14, the sensor unit 10 and the fixing member 14 are not in contact with each other. Thus, it is possible to make external vibration hard to be transmitted from the fixing member 14 coupled to the fixing portion 12 to the sensor unit 10. For this reason, it is possible to obtain the inertial measurement device 1 with an excellent vibration-proof characteristic.

When the angular velocity sensor and the acceleration sensor are fixed separately, variation of vibration attenuation characteristics of a fixing member for an angular velocity sensor and a fixing member for an acceleration sensor should be taken into consideration. On the other hand, in the sensor unit 10 of the embodiment, the incorporated angular velocity sensors 66x, 66y, and 66z and the acceleration sensor 67 are fixed to the common fixing portion 12 using the common fixing members 14 and elastic members 16. Accordingly, since the above-described variation does not need to be taken into consideration, processing of eliminating an influence of external vibration from signals output from the angular velocity sensors 66x, 66y, and 66z and the acceleration sensor 67 is facilitated.

The elastic member 16 includes the control member 22 that controls the pressing amount of the elastic member 16 to the fixing member 14, and the gap is provided between the fixing member 14 and the control member 22. Thus, it is possible to restrain significant deformation of the elastic member 16 due to excessive pressing of the fixing member 14. Furthermore, it is possible to easily insert the fixing member 14 into the elastic member 16 having the control member 22.

The support member 18 is provided between the sensor unit 10 and the fixing portion 12, and the support member 18 is formed of the same material as the elastic member 16 and has the same thickness as the second portion 16b of the elastic member 16. Thus, it is possible to fix and maintain the sensor unit 10 substantially horizontally with respect to the fixing portion 12, and to measure inertia with high accuracy.

### 1.2. Second Embodiment

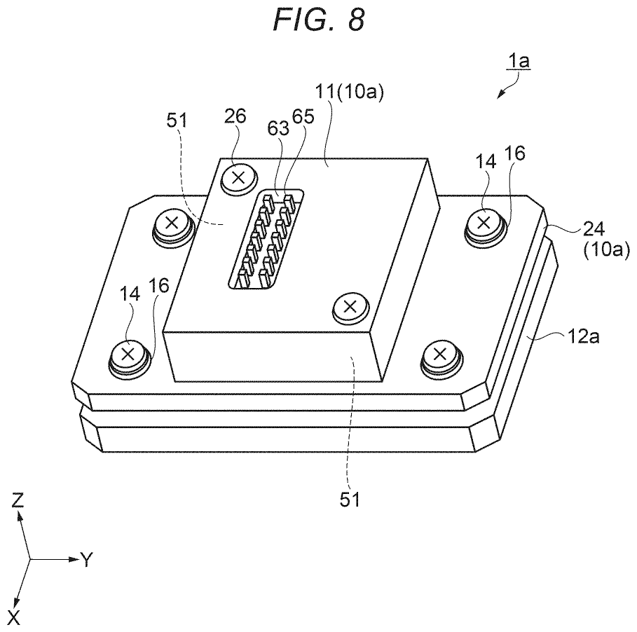

Next, an inertial measurement device 1a according to a second embodiment will be described referring to FIG. 8.

The inertial measurement device 1a of the embodiment is the same as the inertial measurement device 1 of the first embodiment, excluding that a substrate 24 is included in a sensor unit 10a, and four places of the substrate 24 are fixed to a fixing portion 12a by fixing members 14, compared to the inertial measurement device 1 of the first embodiment. Description will be provided focusing on differences from the above-described first embodiment, and description of the same matters will not be repeated.

The sensor unit 10a of the inertial measurement device 1a includes a sensor 11 and the substrate 24. The sensor 11 has the same structure as the sensor unit 10 of the first embodiment. As shown in FIG. 8, the sensor 11 of the sensor unit 10a is fixed to the substrate 24 by screws 26 in screw holes 51 provided at two places. The substrate 24 to which the sensor 11 is fixed is fixed to the fixing portion 12a by the fixing members 14 at four places in the periphery of the sensor 11 with the elastic members 16 sandwiched between the substrate 24 and the fixing portion 12a.

The elastic members 16 are disposed and fixed between the substrate 24 to which the sensor 11 is fixed and the fixing portion 12a and between the substrate 24 to which the sensor 11 is fixed and the fixing members 14. Thus, it is possible to obtain the same effects as the inertial measurement device 1 of the first embodiment.

### 1.3. Third Embodiment

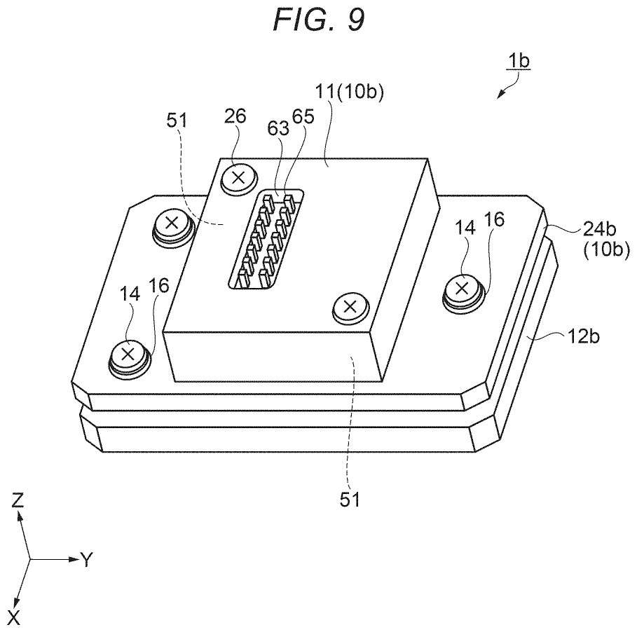

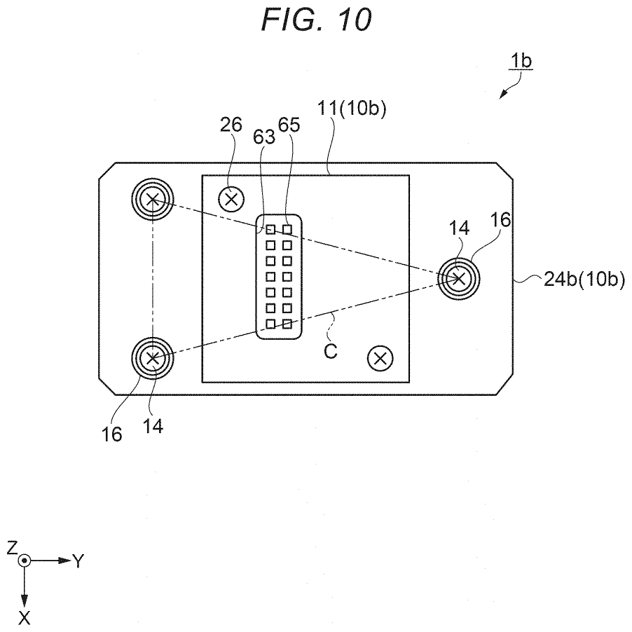

Next, an inertial measurement device 1b according to a third embodiment will be described referring to FIGS. 9 and 10.

The inertial measurement device 1b of the embodiment is the same as the inertial measurement device 1 of the first embodiment, excluding that a substrate 24b is included in a sensor unit 10b, and three places of the substrate 24b are fixed to a fixing portion 12b by fixing members 14, compared to the inertial measurement device 1 of the first embodiment. Description will be provided focusing on differences from the above-described first embodiment, and description of the same matters will not be repeated.

The sensor unit 10b of the inertial measurement device 1b includes a sensor 11 and the substrate 24b. The sensor 11 has the same structure as the sensor unit 10 of the first embodiment. As shown in FIGS. 9 and 10, the sensor 11 of the sensor unit 10b is fixed to the substrate 24b by screws 26 in screw holes 51 provided at two places. The substrate 24b to which the sensor 11 is fixed is fixed to the fixing portion 12b by the fixing members 14 at three places in the periphery of the sensor 11 with elastic members 16 sandwiched between the substrate 24b and the fixing portion 12b. The sensor unit 10b is disposed in a region overlapping a region C having a triangular shape with the three fixing members 14 as vertices in plan view. Specifically, the sensor 11 is disposed in the region overlapping the region C.

The elastic members 16 are disposed and fixed between the substrate 24b to which the sensor 11 is fixed and the fixing portion 12b and between the substrate 24b to which the sensor 11 is fixed and the fixing members 14. Thus, it is possible to obtain the same effects as the inertial measurement device 1 of the first embodiment. The substrate 24b to which the sensor 11 is fixed is fixed to the fixing portion 12b at the three places, and the sensor unit 10b is disposed in the region overlapping the region C having the triangular shape with the three fixing members 14 as the vertices in plan view. For this reason, it is possible to fix and maintain the sensor unit 10b substantially horizontally with respect to the fixing portion 12b, and to measure inertia with high accuracy.

### 1.4. Fourth Embodiment

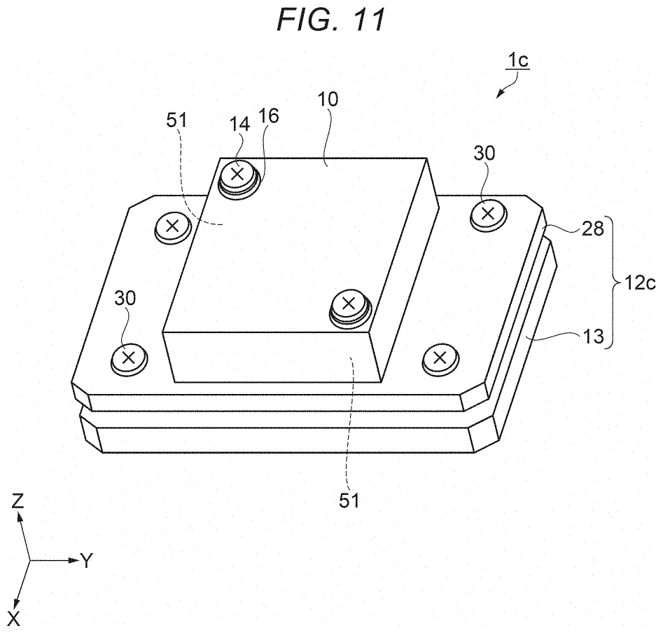

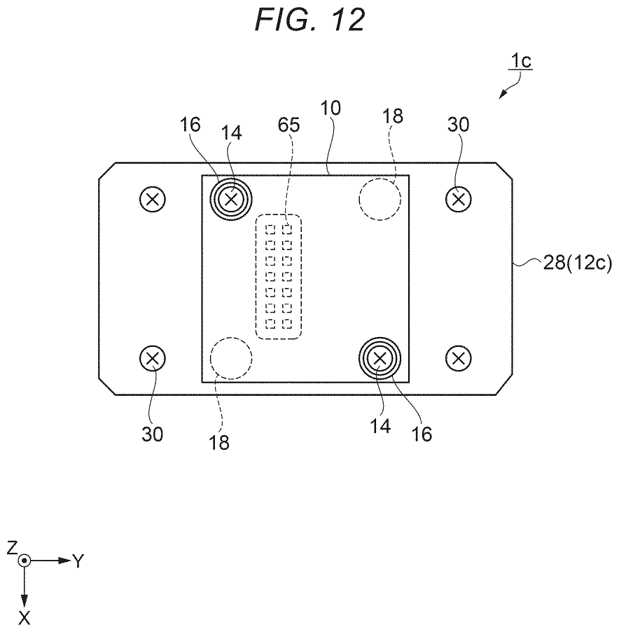

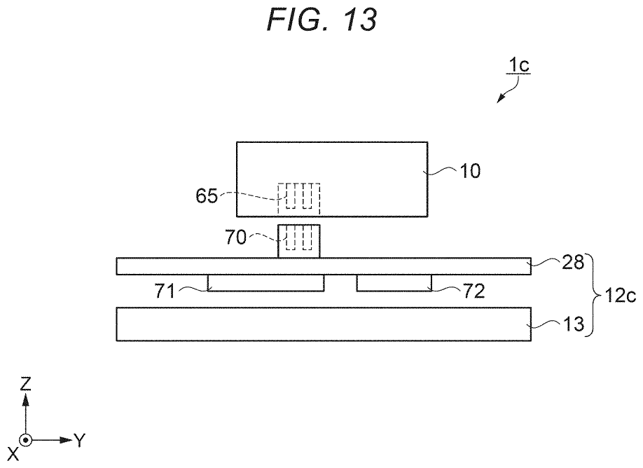

Next, an inertial measurement device 1c according to a fourth embodiment will be described referring to FIGS. 11, 12, and 13.

The inertial measurement device 1c of the embodiment is the same as the inertial measurement device 1 of the first embodiment, excluding that a fixing plate 13, a circuit substrate 28, and a second connector 70 are included in a fixing portion 12c, and the second connector 70 of the circuit substrate 28 and a first connector 65 of a sensor unit 10 are fitted to each other, compared to the inertial measurement device 1 of the first embodiment. Description will be provided focusing on differences from the above-described first embodiment, and description of the same matters will not be repeated.

The fixing portion 12c of the inertial measurement device 1c includes the fixing plate 13, the circuit substrate 28, and the second connector 70. As shown in FIGS. 11, 12, and 13, the circuit substrate 28 of the fixing portion 12c is fixed to the fixing plate 13 by four screws 30 in the periphery of the sensor unit 10. The second connector 70 is mounted on a surface of the circuit substrate 28 on the sensor unit 10 side, and electronic components 71 and 72 configuring a control circuit, and a plurality of electronic components (not shown) are mounted on a surface of the circuit substrate 28 on the fixing portion 12c side. The second connector 70, the electronic components 71 and 72, and the like are electrically coupled.

The sensor unit 10 is fixed to the circuit substrate 28 by fixing members 14 in screw holes 51 provided at two places with elastic members 16 sandwiched between the sensor unit 10 and the circuit substrate 28 such that a surface on which the first connector 65 is provided turns the fixing portion 12c side. The second connector 70 of the circuit substrate 28 and the first connector 65 of the sensor unit 10 are fitted to each other and are electrically coupled to each other. For this reason, it is possible to make connection to a control circuit that performs control based on detection signals output from the sensor unit 10.

The elastic members 16 are disposed and fixed between the circuit substrate 28 fixed to the fixing plate 13 and the sensor unit 10 and between the fixing members 14 and the sensor unit 10. Thus, it is possible to obtain the same effects as the inertial measurement device 1 of the first embodiment. The first connector 65 of the sensor unit 10 and the second connector 70 of the circuit substrate 28 are close to each other and are fitted to each other. Thus, it is possible to reduce an influence of noise between the first connector 65 and the second connector 70.

### 1.5. Fifth Embodiment

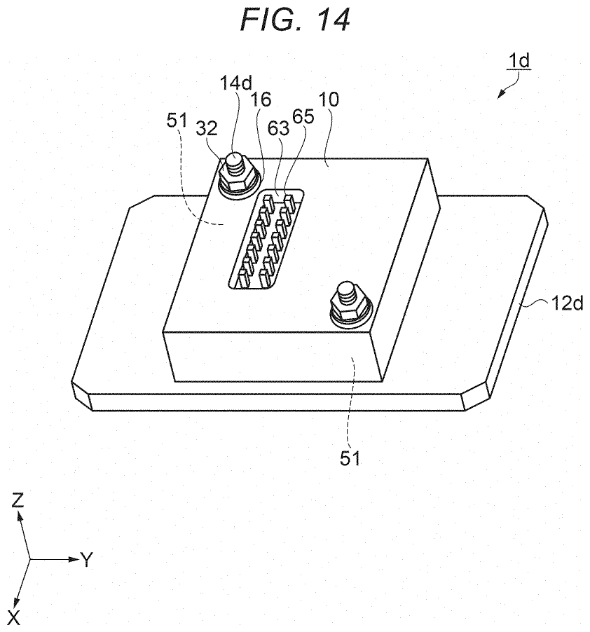

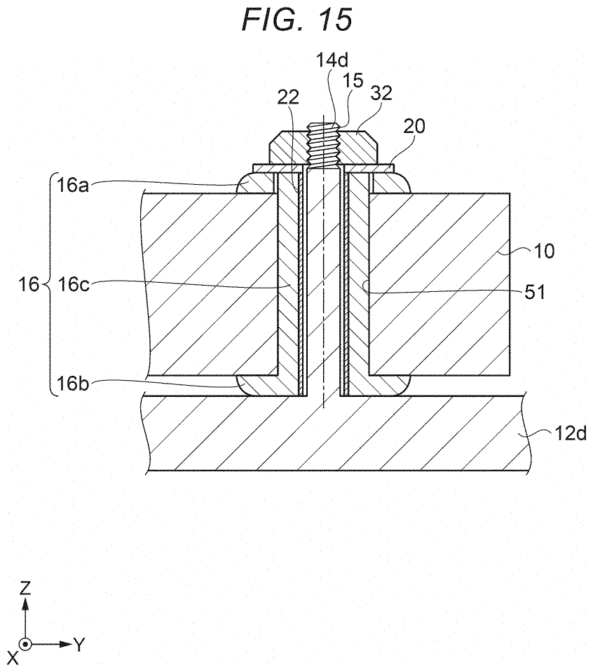

Next, an inertial measurement device 1d according to a fifth embodiment will be described referring to FIGS. 14 and 15.

The inertial measurement device 1d of the embodiment is the same as the inertial measurement device 1 of the first embodiment, excluding that fixing members 14d have a different configuration, compared to the inertial measurement device 1 of the first embodiment. Description will be provided focusing on differences from the above-described first embodiment, and description of the same matters will not be repeated.

As shown in FIGS. 14 and 15, in the inertial measurement device 1d, the fixing members 14d are integrated with a fixing portion 12d and extend to the sensor unit 10 side. A screw thread is formed in the vicinity of a tip end of the fixing member 14d, a nut 32 is screwed to press an elastic member 16 through a washer 20, and the sensor unit 10 is fixed to the fixing portion 12d.

The elastic members 16 are disposed and fixed between the fixing portion 12d and the sensor unit 10 and between the fixing members 14d and the sensor unit 10. Thus, it is possible to obtain the same effects as the inertial measurement device of the first embodiment. The fixing members 14d are integrated with the fixing portion 12d. For this reason, on the fixing member 14d, a second portion 16b, a third portion 16c, and a control member 22 of the elastic member 16 are first inserted, then, the screw hole 51 of the sensor unit 10 is inserted, and the first portion 16a of the elastic member 16 is inserted. In this way, assembly for fixing the sensor unit 10 to the fixing portion 12d is facilitated.

### 2. Electronic Apparatus

Next, description will be provided for a smartphone 400 as an example of an electronic apparatus including the inertial measurement device 1, . . . , or 1d of the embodiment will be described. In the following description, a configuration in which the inertial measurement device 1 is applied will be illustrated and described. Reduction in size can also be made, for example, to be mounted on the smartphone 400 by selection of components or design change.

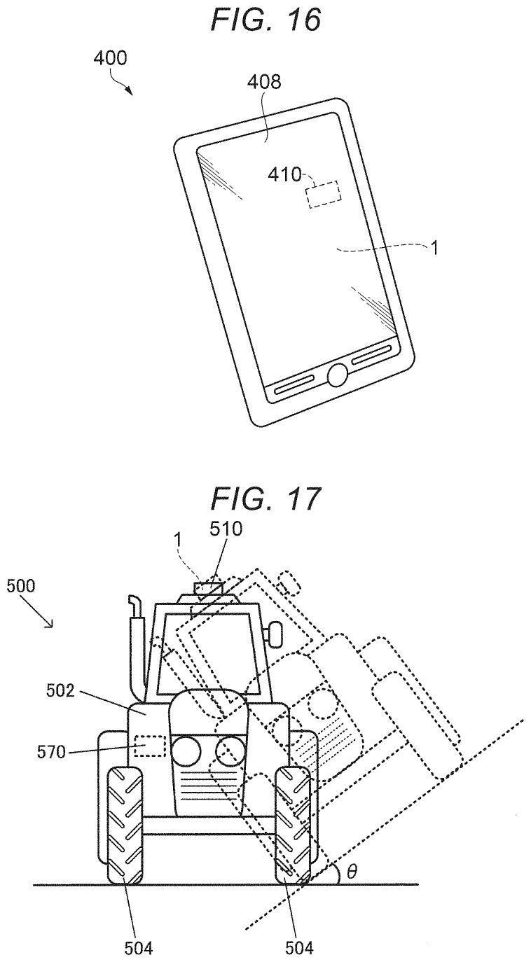

As shown in FIG. 16, the smartphone 400 incorporates the inertial measurement device 1, and a control circuit 410 as a controller that performs control based on detection signals output from the inertial measurement device 1. Detection data detected by the inertial measurement device 1 is transmitted to the control circuit 410, and the control circuit 410 can recognize a posture or behavior of the smartphone 400 from the received detection data, and can change an image displayed on a display 408, generate alarm sound or sound effect, or drive a vibration motor to vibrate a main body.

The smartphone 400 as such an electronic apparatus includes the inertial measurement device 1. Thus, it is possible to obtain the above-described effects of the inertial measurement device 1, and to exhibit high reliability.

The electronic apparatus that incorporates the inertial measurement device 1 is not particularly limited, and in addition to the smartphone 400, for example, a personal computer, a digital still camera, a tablet terminal, a timepiece, a smartwatch, an ink jet printer, a laptop personal computer, a television, a wearable terminal, such as a head-mounted display (HMD), a video camera, a video tape recorder, a car navigation device, a pager, an electronic datebook, an electronic dictionary, a calculator, an electronic game machine, a word processor, a work station, a videophone, a security television monitor, electronic binoculars, a POS terminal, medical equipment, a fish finder, various measuring instrument, equipment for mobile terminal base station, various instrument of a vehicle, an airplane, and a ship, a flight simulator, a network server, and the like.

### 3. Moving Object

Next, description will be provided for a four-wheeled vehicle 500 as an example of a moving object including the inertial measurement device 1, . . . , or 1d of the embodiment. In the following description, a configuration in which the inertial measurement device 1 is applied will be illustrated and described.

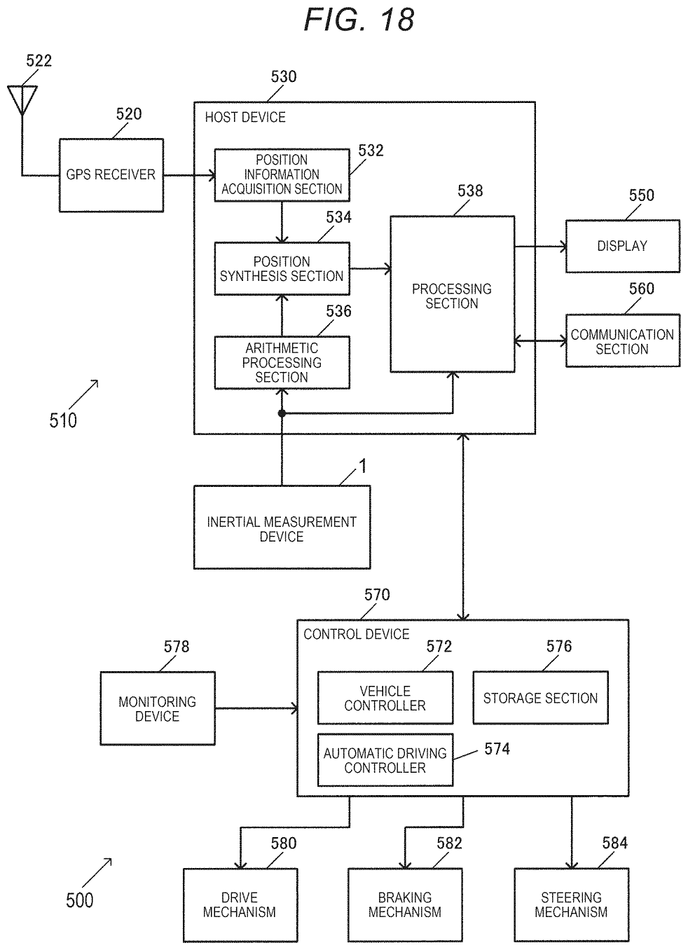

As shown in FIG. 17, the four-wheeled vehicle 500 has a vehicle body 502 and wheels 504. In the four-wheeled vehicle 500, a positioning device 510 including the inertial measurement device 1 is mounted, and a control device 570 as a posture controller that performs posture control or the like based on detection signals output from the inertial measurement device 1 is provided. As shown in FIG. 18, the four-wheeled vehicle 500 has a drive mechanism 580, such as an engine or a motor, a braking mechanism 582, such as a disk brake or a drum brake, and a steering mechanism 584 that is realized by a steering wheel, a steering gear box, and the like.

The positioning device 510 is a device that is mounted on the four-wheeled vehicle 500 and performs positioning of the four-wheeled vehicle 500. The positioning device 510 includes the inertial measurement device 1, a GPS receiver 520, an antenna 522 for GPS reception, and a host device 530. The host device 530 includes a position information acquisition section 532, a position synthesis section 534, an arithmetic processing section 536, and a processing section 538.

The arithmetic processing section 536 receives acceleration data and angular velocity data from the three-axis acceleration sensor 67 and the three-axis angular velocity sensors 66x, 66y, and 66z of the inertial measurement device 1, executes inertial navigation arithmetic processing on the received data, and output inertial navigation positioning data. The inertial navigation positioning data is data representing the acceleration or the posture of the four-wheeled vehicle 500.

The GPS receiver 520 receives signals from GPS satellites through the antenna 522. The position information acquisition section 532 outputs GPS positioning data representing a position, a speed, and an azimuth of the four-wheeled vehicle 500, on which the positioning device 510 is mounted, based on the signals received by the GPS receiver 520. The position synthesis section 534 calculates a position on the ground where the four-wheeled vehicle 500 is traveling based on the inertial navigation positioning data output from the arithmetic processing section 536 and the GPS positioning data output from the position information acquisition section 532. For example, even though the position of the four-wheeled vehicle 500 included in the GPS positioning data is the same, when the posture of the four-wheeled vehicle 500 differs due to an influence of an inclination (θ) of the ground as shown in FIG. 17, the four-wheeled vehicle 500 is traveling at a different position on the ground. For example, an accurate position of the four-wheeled vehicle 500 cannot be calculated only with the GPS positioning data. Therefore, the position synthesis section 534 calculates a position on the ground where the four-wheeled vehicle 500 is traveling using, in particular, data relating to the posture of the four-wheeled vehicle 500 out of the inertial navigation positioning data. Position data output from the position synthesis section 534 is subjected to predetermined processing by the processing section 538 and is displayed on a display 550 as a positioning result. The position data may be transmitted to an external device by a communication section 560.

The control device 570 performs control of the drive mechanism 580, the braking mechanism 582, and the steering mechanism 584 of the four-wheeled vehicle 500. The control device 570 is a controller for vehicle control, and can be realized by, for example, a plurality of control units. The control device 570 has a vehicle controller 572 as a control unit that performs vehicle control, an automatic driving controller 574 as a control unit that performs automatic driving control, and a storage section 576 that is realized by a semiconductor memory or the like. A monitoring device 578 is a device that monitors an object, such as an obstacle around the four-wheeled vehicle 500, and is realized by a surrounding monitoring camera, a millimeter wave radar, a sonar, or the like.

As shown in FIG. 18, the four-wheeled vehicle 500 of the embodiment includes the inertial measurement device 1 and the control device 570. The control device 570 performs control of the posture of the four-wheeled vehicle 500 based on information regarding the posture of the four-wheeled vehicle 500 obtained through processing based on output signals of the inertial measurement device 1. For example, the host device 530 executes various kinds of processing described above based on the output signals including the detection data from the inertial measurement device 1 and obtains information regarding the position or the posture of the four-wheeled vehicle 500. For example, information regarding the position of the four-wheeled vehicle 500 can be obtained based on the GPS positioning data and the inertial navigation positioning data as described above. Information regarding the posture of the four-wheeled vehicle 500 can be obtained based on, for example, the angular velocity data and the like included in the inertial navigation positioning data. Information regarding the posture of the four-wheeled vehicle 500 is, for example, information regarding rotational motion of rolling, pitching, or yawing, and can be represented by a roll angle, a pitch angle, a yaw angle, or the like. The control device 570 performs control of the posture of the four-wheeled vehicle 500 based on, for example, information regarding the posture of the four-wheeled vehicle 500 obtained through processing of the host device 530. The control is performed by, for example, the vehicle controller 572. The control of the posture can be realized by, for example, the control device 570 controlling the steering mechanism 584. Alternatively, in control for stabilizing the posture of the four-wheeled vehicle 500, such as slip control, the control device 570 may control the drive mechanism 580 or the braking mechanism 582. According to the embodiment, it is possible to obtain information regarding the posture obtained by the output signals of the inertial measurement device 1 with high accuracy. Thus, it is possible to realize appropriate posture control of the four-wheeled vehicle 500.

In the embodiment, the control device 570 controls at least one of acceleration, braking, and steering of the four-wheeled vehicle 500 based on information regarding the position and the posture of the four-wheeled vehicle 500 obtained through the processing based on the output signals of the inertial measurement device 1. For example, the control device 570 controls at least one of the drive mechanism 580, the braking mechanism 582, and the steering mechanism 584 based on information regarding the position and the posture of the four-wheeled vehicle 500. With this, for example, it is possible to realize automatic driving control of the four-wheeled vehicle 500 by the automatic driving controller 574. In the automatic driving control, a monitoring result of a surrounding object by the monitoring device 578 or map information, traveling route information, or the like stored in the storage section 576 is used in addition to information regarding the position and the posture of the four-wheeled vehicle 500. The control device 570 switches between execution or non-execution of automatic driving of the four-wheeled vehicle 500 based on a monitoring result of the output signals of the inertial measurement device 1. For example, the host device 530 monitors the output signals, such as detection data from the inertial measurement device 1. For example, when degradation of detection accuracy or a sensing abnormality in the inertial measurement device 1 is detected based on the monitoring result, the control device 570 switches execution of automatic driving to non-execution of automatic driving. For example, in automatic driving, at least one of acceleration, braking, and steering of the four-wheeled vehicle 500 is automatically controlled. On the other hand, in non-execution of automatic driving, such automatic control of acceleration, braking, and steering is not performed. In this way, it is possible to perform support with higher reliability on traveling of the four-wheeled vehicle 500 that performs automatic driving. Automation levels of automatic driving may be switched based on the monitoring result of the output signals of the inertial measurement device 1.

As the moving object in which the inertial measurement device 1 is incorporated is not particularly limited, and for example, a two-wheeled vehicle, such as a motorcycle, a vehicle, an airplane, a ship, and the like are exemplified in addition to the four-wheeled vehicle 500.

What is claimed is:

1. An inertial measurement device comprising:
a sensor unit that has an angular velocity sensor and an acceleration sensor;
an elastic member that has a first portion, a second portion facing the first portion, and a third portion coupled to the second portion, and sandwiches the sensor unit between the first portion and the second portion;
a fixing portion on which the sensor unit and the elastic member are disposed and which is in contact with the second portion; and
a fixing member that fixes the sensor unit and the elastic member to the fixing portion, wherein
the fixing member passes through the sensor unit and the elastic member, and presses and fixes the elastic member, and
the third portion of the elastic member is positioned between the sensor unit and the fixing member.

2. The inertial measurement device according to claim 1, wherein
the sensor unit includes a substrate.

3. The inertial measurement device according to claim 1, wherein
the elastic member is a gelatinous or rubbery bushing.

4. The inertial measurement device according to claim 1, wherein
the elastic member includes a control member that controls a pressing amount of the elastic member to the fixing member, and
a gap is provided between the fixing member and the control member.

5. The inertial measurement device according to claim 1, wherein
a support member is provided between the sensor unit and the fixing portion, and
the support member is formed of the same material as the elastic member and has the same thickness as the second portion.

6. The inertial measurement device according to claim 1, wherein
three places of the sensor unit are fixed by the fixing member, and
the sensor unit is disposed in a region overlapping a region having a triangular shape with the three places as vertices in plan view.

7. The inertial measurement device according to claim 1, wherein
the sensor unit includes a first connector,
the fixing portion includes a circuit substrate and a second connector,
the first connector and the second connector are fitted to each other.

8. An electronic apparatus comprising:
the inertial measurement device according to claim 1; and
a controller that performs control based on a detection signal output from the inertial measurement device.

9. A moving object comprising:
the inertial measurement device according to claim 1; and
a posture controller that performs control of a posture based on a detection signal output from the inertial measurement device.
